(19) United States
(12) Patent Application Publication
(10) Pub. No.: US 2018/0143750 A1
(43) Pub. Date: May 24, 2018

(54) METHODS AND APPARATUSES FOR CONFIGURING MESSAGE PROPERTIES IN A NETWORKED COMMUNICATIONS SYSTEM

(71) Applicant: Alibaba Group Holding Limited, Grand Cayman (KY)

(72) Inventor: Jun YE, Hangzhou (CN)

(21) Appl. No.: 15/818,833

(22) Filed: Nov. 21, 2017

(30) Foreign Application Priority Data
Nov. 22, 2016 (CN) 201611048596.8

(51) Int. Cl. G06F 3/0482; G06F 3/0488; G06F 17/21

(52) U.S. Cl. CPC G06F 3/0482; G06F 17/214; G06F 3/0488

(57) ABSTRACT

The present application provides methods and apparatuses for configuring properties of messages transmitted in a networking communications system. In one embodiment, the method comprises: identifying message content in an input box of a communication session page of a communication application; recording an implementation degree of a trigger operation for a preset dimension in response to detecting the trigger operation; and sending the message content and the implementation degree to a peer device, wherein the implementation degree causes the peer device to configure a display attribute of the message content, such that the display attribute of the message content matches a predefined display attribute corresponding to the implementation degree. In the disclosed embodiments, a display attribute of message content can be quickly set, and the amount of data transmitted and the amount of space occupied can be reduced, and communication efficiency can be improved.

### CROSS-REFERENCE TO RELATED APPLICATIONS

This application claims the benefit of priority of Chinese Application No. 201611048596.8, titled “Method and Apparatus for Communication,” filed on Nov. 22, 2016, which is hereby incorporated by reference in its entirety.

### BACKGROUND

### Technical Field

The present application relates to the field of communications technologies, and in particular, to methods and apparatuses for configuring properties of messages transmitted in a networking communications system.

### Description of the Related Art

A common practice of sending a communication message is that a user may want to set a display attribute of the message content (e.g., making the message content bold or enlarging or underlining the message content) to achieve the goals like marking important information or expressing special meaning. However, the process of setting a display attribute in the relevant art still has the following problems.

The setting process in the relevant art is complicated. On the one hand, the user needs to set up the attribute setting menu beforehand to complete a setting operation on a display attribute. Because the setting operation is not united with the user's sending operation on the message content, the user's operations become more complicated. On the other hand, the setup of the attribute setting menu applies to all the communication messages on the same communication session page. When the user wants to use a display attribute B for a certain communication message, the user needs to change the original display attribute A to the display attribute B through the attribute setting menu before sending the communication message; and the original display attribute A would need to be changed back from the current display attribute B through the attribute setting menu after sending the communication message. These steps are necessary so that all the subsequent communication messages will not be sent using the display attribute B.

Meanwhile, message content and a display attribute are recorded in a mixed manner in the relevant art. This results in a large amount of communication message data, which needs to consume a large amount of communication resources during transmission and needs to take up a large storage space during storage.

### BRIEF SUMMARY

Given the problems mentioned above, the present application provides a communication method and apparatus, designed to quickly set up a display attribute of message content, which in turn helps to reduce the amount of data transmitted and the amount of space occupied, improving the communication efficiency.

To achieve the aforementioned objective, the present application provides the following technical solutions.

In one embodiment, a method is disclosed comprising: identifying message content in an input box of a communication session page of a communication application; recording an implementation degree of a trigger operation for a preset dimension in response to detecting the trigger operation; and sending the message content and the implementation degree to a peer device, wherein the implementation degree causes the peer device to configure a display attribute of the message content, such that the display attribute of the message content matches a predefined display attribute corresponding to the implementation degree

In another embodiment, an apparatus is disclosed comprising a processor; and a storage medium for tangibly storing thereon program logic for execution by the processor, the stored program logic comprising: logic for identifying message content in an input box of a communication session page of a communication application; logic for recording an implementation degree of a trigger operation for a preset dimension in response to detecting the trigger operation; and logic for sending the message content and the implementation degree to a peer device, wherein the implementation degree causes the peer device to configure a display attribute of the message content, such that the display attribute of the message content matches a predefined display attribute corresponding to the implementation degree.

In another embodiment, a method is disclosed comprising displaying a candidate matching a detected user input operation according to the user input operation; detecting a trigger operation and recording an implementation degree of the trigger operation on a preset dimension; performing a configuration operation on a display attribute of the candidate corresponding to the trigger operation, the display attribute matching a predefined display attribute corresponding to the implementation degree; and inputting the candidate with the configuration operation being completed

It can be seen from the above technical solutions that in the present application, by recording implementation degree information of a trigger operation, a user can set up a display attribute of each message content simply through different degrees of implementation of the trigger operation applied on a transmission control, thereby greatly simplifying a user's setting operation on the display attribute. At the same time, the implementation degree information is used as independent information associated with the message content, so that mixed recording of the message content and the display attribute is avoided and the data amount of a communication message can then be reduced. Through the technical solutions, the amount of data transmitted during communication can be reduced; and the amount of space occupied during message storage can also be reduced, thereby increasing the speed of message sending and enhancing the communication efficiency.

### BRIEF DESCRIPTION OF THE DRAWINGS

FIG. 1 is a user interface diagram of a communication session page utilized by current systems.

FIG. 2 is a flow diagram illustrating a communication method from the perspective of a sender according to some embodiments of the disclosure.

FIG. 3 is a flow diagram illustrating a communication method from the perspective of a receiver according to some embodiments of the disclosure.

FIG. 4 is a flow diagram illustrating a communication method according to some embodiments of the disclosure.

FIGS. 5 through 8D are user interface diagrams of a communication session page according to some embodiments of the disclosure.

FIG. 9 is a flow diagram illustrating another communication method according to some embodiments of the disclosure.

FIGS. 10 to 11 are schematic diagrams of another communication session page according to some embodiments of the disclosure.

FIG. 12 is a flow diagram illustrating a further communication method according to some embodiments of the disclosure.

FIG. 13 is a schematic diagram of a further communication session page according to some embodiments of the disclosure.

FIG. 14 is a flow diagram illustrating another communication method based on a displayer according to some embodiments of the disclosure.

FIGS. 15 to 19 are schematic diagrams of a further communication session page according to some embodiments of the disclosure.

FIG. 20 is a block diagram of an electronic device according to some embodiments of the disclosure.

FIG. 21 is a block diagram of a communication apparatus according to some embodiments of the disclosure.

FIG. 22 is a block diagram of another electronic device according to some embodiments of the disclosure.

FIG. 23 is a block diagram of another communication apparatus according to some embodiments of the disclosure.

FIG. 24 is a block diagram of an electronic device according to some embodiments of the disclosure.

FIG. 25 is a block diagram of a communication apparatus according to some embodiments of the disclosure.

FIG. 26 is a flow diagram illustrating an input method according to some embodiments of the disclosure.

FIGS. 27 to 29 are schematic diagrams of an input page according to some embodiments of the disclosure.

FIG. 30 is a schematic structural diagram of an electronic device according to some embodiments of the disclosure.

FIG. 31 is a block diagram of an input apparatus according to some embodiments of the disclosure.

### DETAILED DESCRIPTION

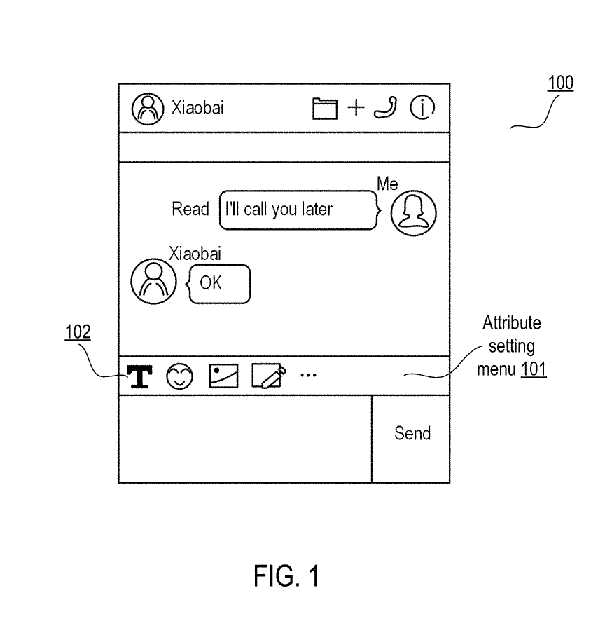

FIG. 1 is a user interface diagram of a communication session page utilized by current systems.

As shown in FIG. 1, when a user wants to modify a display attribute of message content during communication, the user needs to perform a modification operation through a setting option in an attribute setting menu 101 provided by the communication session page 100. For example, when the user wants to modify a display attribute of a text message in the message content, the modification may be done through the leftmost “T” setting option 102 in the attribute setting menu 101.

However, this interaction has the following technical problems.

First, the user needs to separately set up an attribute setting menu to complete a setting operation on a display attribute. Because the setting operation is not united with the user's sending operation on the message content, the user's operations become more complicated.

Second, the setup of the attribute setting menu applies to all the communication messages on the same communication session page. When the user wants to use a display attribute B for a certain communication message, the user needs to change the original display attribute A to the display attribute B through the attribute setting menu before sending the communication message. The original display attribute A will need to be changed back from the current display attribute B through the attribute setting menu after sending the communication message. These steps are necessary so that all the subsequent communication messages will not be sent using the display attribute B. As a result, the user's operations become more complicated.

Third, the message content and the display attribute are recorded in a mixed manner in current systems. This results in a large amount of communication message data, which consumes a large amount of communication resources during transmission and requires significant storage space.

Therefore, the present application improves the communication manner to solve the technical problems existing in current technologies. The following embodiments are provided to further describe the technical solutions.

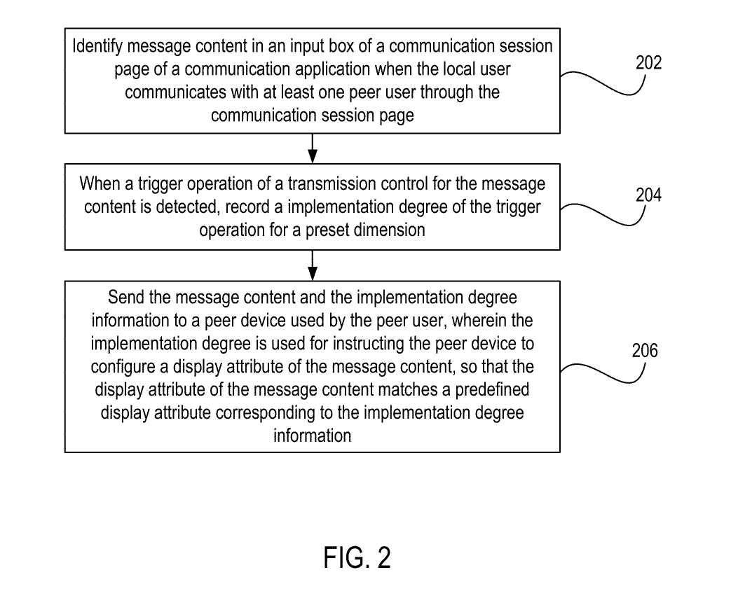

FIG. 2 is a flow diagram illustrating a communication method from the perspective of a sender according to some embodiments of the disclosure. As shown in FIG. 2, the method is applied to a local device (e.g., an electronic device used by a local user) and may include the following steps.

Step 202: Identify message content in an input box of a communication session page of a communication application when the local user communicates with at least one peer user through the communication session page.

In one embodiment, the type of the communication application is not intended to limit the disclosed embodiments. By way of example, the communication application may be an instant messaging application. For example, the instant messaging application may be an enterprise instant messaging (EIM) application (e.g., “DING TALK”).

In one embodiment, a client application (“app”) of a communication application is installed on a local device. By logging into the communication application using a registered account of a local user, the local device can be configured to be used as a client of the communication application for the local user. Likewise, a peer device (e.g., an electronic device used by a peer user) is configured so that it can be used as a client of the communication application for the peer user. The local device (or peer device) may be a mobile device such as a mobile phone or a tablet. Alternatively, the local device (or peer device) may be a non-mobile electronic device such as a laptop or desktop. The choice of non-mobile device is not intended to limit the disclosed embodiments. Certainly, when an online “client” implemented in HTML5 technology is used, a client of the communication application can be obtained and run without the need to install the aforementioned application of the communication application on the local device (or peer device).

In one embodiment, when the local user communicates with one peer user, the aforementioned message session page may be a private chat page between the local user and the peer user. When the local user communicates with multiple peer users, the aforementioned message session page may be a group chat page between the local user and the multiple peer users. In fact, the local user can set up a display attribute of message content on any form of communication session page based on the technical solutions described herein.

Step 204: When a trigger operation of a transmission control for the message content is detected, record an implementation degree of the trigger operation for a preset dimension.

In one embodiment, since the transmission control itself is applied to a sending operation on message content, the local user only needs to adjust the implementation degree of a trigger operation on the transmission control to adjust and configure a display attribute of message content without needing to perform additional operations such as sliding in the technical solution of the present application. In other words, operational actions to be performed by the local user are the same as operational actions on the transmission control. The only difference lies in the degrees of implementation, which does not increase the operational complexity of the local user.

The preset dimension may include at least one of the following, which is not limited in the disclosed embodiments.

1) Duration dimension. The local device may obtain implementation degree of the trigger operation on a duration dimension. For example, the implementation degree information may be trigger duration information, i.e., the length of time during which the trigger operation lasts.

2) Pressure dimension. The local device may obtain implementation degree of the trigger operation on a pressure dimension. For example, the implementation degree information may be trigger pressure information, i.e., the pressure value resulted from the trigger operation.

3) Touch area dimension. The local device may obtain implementation degree of the trigger operation on a touch area dimension. For example, the implementation degree information may be trigger area information. That is, when the trigger operation includes a touch behavior of the user on the local device, the trigger area information may include a touch area of a touch operation resulted from the touch behavior on a touch display screen of the local device.

In one embodiment, implementation degree of the trigger operation on each preset dimension may be used for indicating at least one display attribute of the message content. For example, when the local device records trigger duration information of the trigger operation on the duration dimension, display attributes of the font and text color of the message content may be set according to the trigger duration information. For another example, when the local device records trigger duration information on the duration dimension and trigger pressure information on the pressure dimension of the trigger operation, a display attribute of the font of the message content may be set according to the trigger duration information; and a display attribute of text color of the message content may be set according to the trigger pressure information. Text is used herein solely as an example. In practice, the message content may include any type of content such as characters (including text, digits, letters, symbols, and so on), static pictures, dynamic pictures, short videos, or long videos, which can have their display attributes quickly set up through the disclosed embodiments, and the type of message content is not intended to be limited.

In one embodiment, the local device may configure the display attribute of the message content in the input box according to a dynamic implementation degree of the trigger operation before the trigger operation ends, so that the display attribute of the message content is configured to match a predefined display attribute. Then, the local user can view the setting of the display attribute of the message content in real time while implementing the trigger operation. The local user can then conveniently select the most appropriate display attribute for the message content.

In one embodiment, the local device may display implementation degree prompt information for the trigger operation on the communication session page. In this embodiment, the implementation degree prompt information is synchronized with the implementation degree information. The implementation degree prompt information may take any form, such as a digital form or a progress bar form, and is not intended to limit the disclosed embodiments. Implementation degree prompt information is displayed so that the local user can easily find out his implementation of the trigger operation, which helps to implement quantitative control on the implementation degree, thereby improving the precision of implementing the trigger operation.

Further, the local device may configure a display attribute of the implementation degree prompt information according to a dynamic implementation degree of the trigger operation before the trigger operation ends, so that the display attribute of the implementation degree prompt information is configured to match the predefined display attribute. The local user will then be able to view the setting of the display attribute of the message content in real time while implementing the trigger operation, which helps the local user to select the most appropriate display attribute for the message content. Meanwhile, through the implementation degree prompt information and a dynamic display of the display attribute (e.g., dynamic configuration of the display attribute of the implementation degree prompt information), the local user can combine both the implementation degree prompt information and the dynamically displayed display attribute, to further improve the precision of the implementation degree of the trigger operation.

Step 206: Send the message content and the implementation degree information to a peer device used by the peer user, wherein the implementation degree information is used for instructing the peer device to configure a display attribute of the message content, so that the display attribute of the message content matches a predefined display attribute corresponding to the implementation degree information.

In one embodiment, the local device may send the message content and the implementation degree information to a server of the communication application. The server may then back up the message content and the implementation degree information in an associated manner and then send the message content associated with the implementation degree information to the peer device. Later, when acquiring relevant historical communication data from the server at any moment, the local user or the peer user may read the aforementioned message content and implementation degree information that are backed up in an associated manner in the historical communication data, to perform a full recovery on a display attribute of the relevant message content. The viewer (the local user or the peer user) will then be able to experience, through the display attribute, the communication at a relevant historical moment (e.g., the historical sending moment of the aforementioned message content), such as the emphasis on the importance of the relevant message content, thereby enabling the viewer to gain a richer message reading experience.

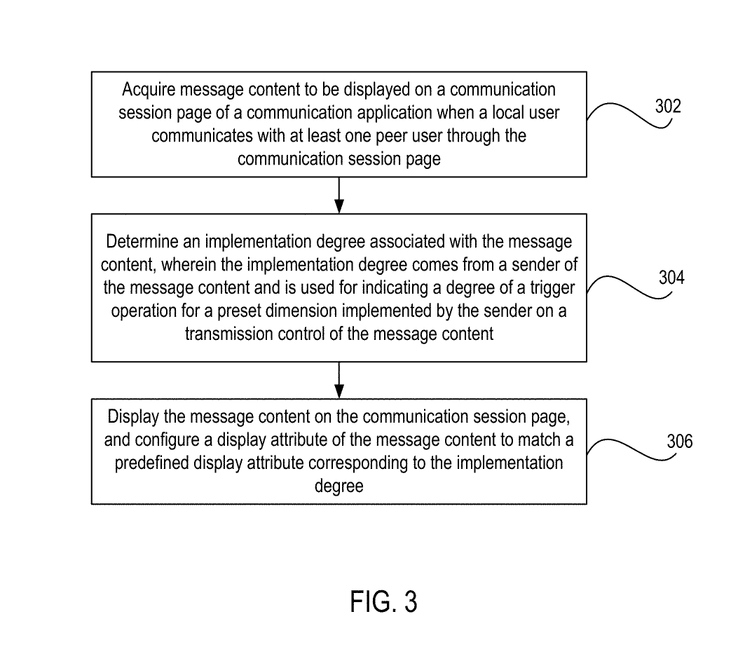

FIG. 3 is a flow diagram illustrating a communication method from the perspective of a receiver according to some embodiments of the disclosure. As shown in FIG. 3, the method is applied to an electronic device used by a receiver (e.g., a device displaying a message) and may include the following steps.

Step 302: Acquire message content to be displayed on a communication session page of a communication application when a local user communicates with at least one peer user through the communication session page.

In one embodiment, the message content may include at least one of the following: a sent message sent by the local user to the peer user or a received message sent by the peer user to the local user.

Step 304: Determine implementation degree information associated with the message content, wherein the implementation degree information comes from a sender of the message content and is used for indicating degree information of a trigger operation for a preset dimension implemented by the sender on a transmission control of the message content.

Step 306: Display the message content on the communication session page, and configure a display attribute of the message content to match a predefined display attribute corresponding to the implementation degree information.

In one embodiment, the message content may come from at least one of the following: a communication message transmitted between the local user and the peer user in real time or historical communication data read by the local user from a local storage space or a server of the communication application.

It can be seen from the above technical solutions that in the disclosed embodiments, by recording implementation degree information of a trigger operation, a user can set up a display attribute of each message content simply through different degrees of implementation of the trigger operation applied on a transmission control, thereby greatly simplifying a user's setting operation on the display attribute. At the same time, the implementation degree information is used as independent information associated with the message content, so that mixed recording of the message content and the display attribute is avoided and the data amount of a communication message can then be reduced. Through the technical solutions described above and herein, the amount of data transmitted during communication can be reduced and the amount of space occupied during message storage can also be reduced, thereby increasing the speed of message sending and enhancing the communication efficiency.

The technical solutions of the disclosed embodiments are described in detail below using a communication session page of any instant messaging application as an example.

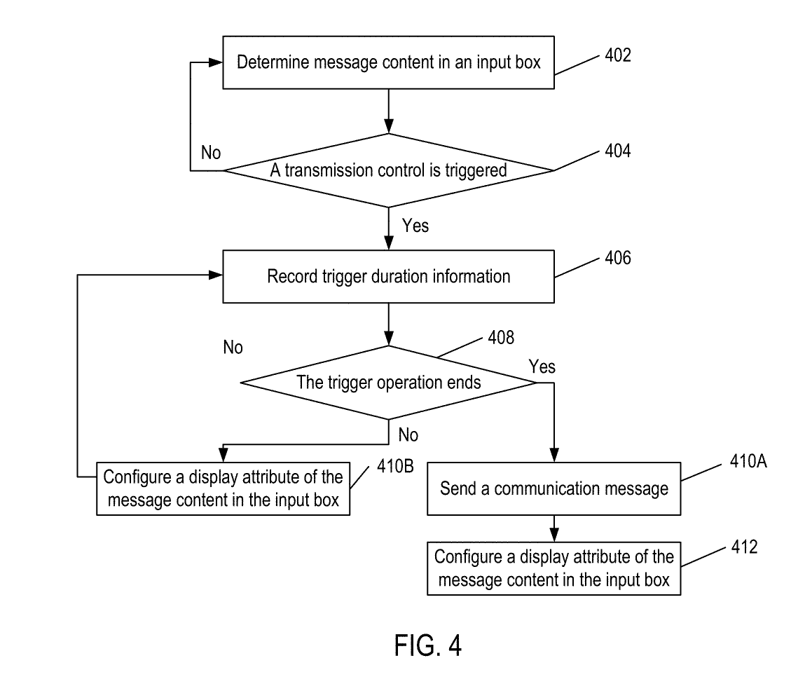

FIG. 4 is a flow diagram illustrating a communication method according to some embodiments of the disclosure. The method is applied to a local device and may include the following steps.

Step 402: The local device determines message content in an input box of a communication session page.

In one embodiment, assuming that a local user is a user “Baibai” and a peer user is a user “Xiaobai”; then, the user “Baibai” has a client 1 of an instant messaging application configured on a local device, and the user “Xiaobai” has a client 2 of the instant messaging application configured on a peer device. Instant messaging through client 1 and client 2 can then be achieved. The terms “local” and “peer” necessarily relative concepts. When the user “Xiaobai” sends a communication message to the user “Baibai”, the user “Xiaobai” becomes the local user and the user “Baibai” becomes the peer user. Here we use the scenario where the user “Baibai” is the local user as an example for description.

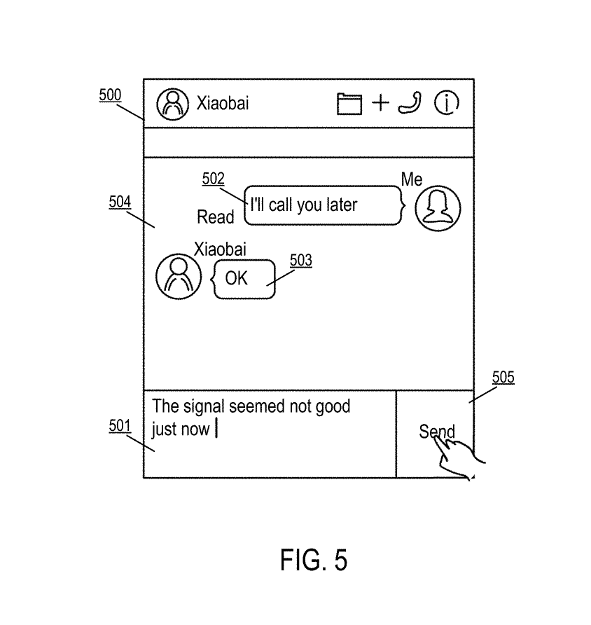

The local device may provide a communication session page like the one shown in FIG. 5.

The user “Baibai” may be able to input any message content in an input box 501 of the communication session page 500 for sending to the user “Xiaobai.” Meanwhile, a sent communication message 502 of the user “Baibai” and a received communication message 503 from the user “Xiaobai” may be displayed respectively on the communication session page. For example, these communication messages may be displayed in a message box 504 shown in FIG. 5 for viewing by the user “Baibai”.

Step 404: When the local device detects that a transmission control for the input box is triggered, move to step 406.

In one embodiment, the message content input by the user “Baibai” to the input box 501 on the communication session page 500 shown in FIG. 5 is “The signal seemed not good just now.” Meanwhile, a transmission control, for example, a “Send” button 505 shown in FIG. 5, for the input box 501 (or the message content in the input box) exists on the communication session page 500 shown in FIG. 5. Then, when the local device is equipped with a touch display screen, the user “Baibai” may touch the “Send” button 505 to complete a trigger operation on the transmission control (e.g., the transmission control is triggered).

Certainly, when the local device is not equipped with a touch display screen, a trigger operation may further be performed on the transmission control through a device such as a mouse or a keyboard, the specific input device not intended to limit the disclosed embodiments. For example, when the user “Baibai” uses a mouse, the user may move the mouse cursor to the “Send” button 505 shown in FIG. 5 and click to complete a trigger operation on the “Send” button 505. As another example, when the user “Baibai” uses a keyboard, the user may press the “Enter” key on the keyboard when the communication session page 500 shown in FIG. 5 is in the foreground and the operating focus is the input box, thereby completing the trigger operation on the “Send” button.

Step 406: The local device records trigger duration information.

In one embodiment, the local device may record implementation degree of the trigger operation for a preset dimension based on the trigger operation performed by the user “Baibai” on the transmission control. By way of example, assuming that the preset dimension includes a duration dimension, then, the implementation degree information may include an implementation degree of the trigger operation on the duration dimension, i.e., trigger duration information of the trigger operation.

Using the trigger operation being a touch of the user “Baibai” on the “Send” button 505 as an example, the local device may acquire a timestamp T1 (the time when the trigger operation occurs) and a timestamp T2 (the time when the trigger operation ends). Then, the trigger duration information may be T=T1−T2. The timestamp T1 and the timestamp T2 may employ a UNIX® timestamp (or UNIX® time, POSIX time) or the like, the choice of timestamp format not intended to limit the disclosed embodiments.

Certainly, in addition to the duration dimension, the aforementioned preset dimension may further include: a pressure dimension, a touch area dimension, and so on; and a combination of the aforementioned multiple preset dimensions may also be used, which will not be described herein again but is included herein by reference.

Step 408: When the local device detects that the trigger operation ends, move to step 410A; otherwise, move step 410B.

Step 410A: The local device sends a communication message to a peer device.

In one embodiment, the local device may include the message content and the trigger duration information in the communication message, so that any device hoping to display the message content of the communication message can configure a display attribute of the message content based on the trigger duration information contained in the communication message.

In other words, a mapping relationship between implementation degree information and display attributes is predefined in the aforementioned client of the instant messaging application. Any client, upon acquiring a communication message containing implementation degree information, may then configure a display attribute of a corresponding message content based on the implementation degree information, to achieve the goal of displaying the message content in a highlighted or focused manner.

It should be noted that when message content and implementation degree information are independent of each other; the implementation degree information has an extremely small data amount. For example, the aforementioned trigger duration information only needs to contain the timestamp T1 and the timestamp T2, and a UNIX® timestamp is only a string of digits (for example, 1474889746 represents 2016/9/2619:35:46). Therefore, compared with current systems in which message content and a display attribute are expressed in a mixed manner, the data amount of each communication message is greatly reduced, so that communication resources occupied during communication are reduced, thereby improving the communication efficiency and reducing the storage space occupied by the communication message.

Step 410B: The local device configures a display attribute of the message content in the input box.

In one embodiment, implementation degree of the trigger operation may dynamically change before the trigger operation ends. For example, when the implementation degree information includes trigger duration information, the amount of the trigger duration information continuously increases with the implementation of the trigger operation. That is, he implementation degree information dynamically changes before the trigger operation ends. Thus, the implementation degree information may be referred to as a dynamic implementation degree of the trigger operation. Meanwhile, since the display attribute of the message content is associated with the implementation degree of the trigger operation, the display attribute of the message content dynamically changes with the dynamic degree of implementation until the implementation degree information is determined as the trigger operation ends.

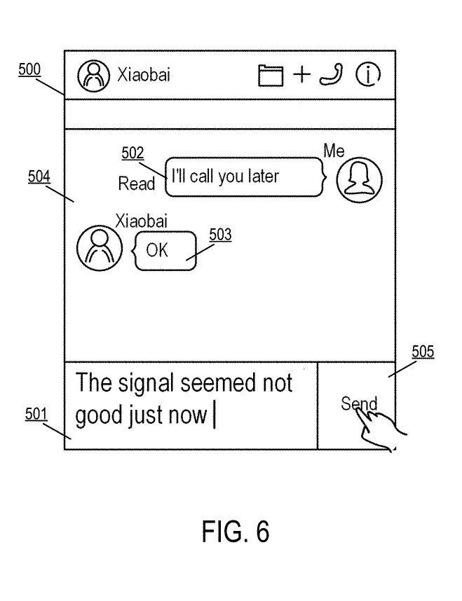

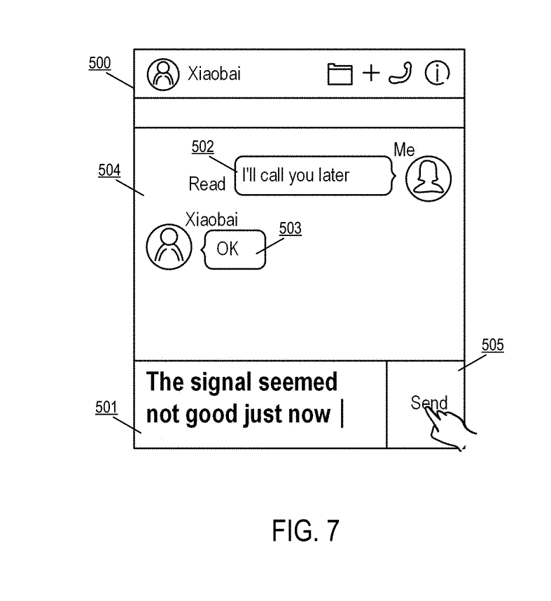

Therefore, to make it convenient for the local user to set the display attribute, the display attribute of the message content may be configured in the input box 501 according to the dynamic implementation degree of the trigger operation. The display attribute of the message content may then be configured to match a predefined display attribute corresponding to the dynamic degree of implementation. By way of example, assuming that the display attribute of the message content to be configured is font size according to the implementation degree of the trigger operation of the local user. Then, still using the user “Baibai” performing a trigger operation on the “Send” button 505 shown in FIG. 5 as an example, the local device may dynamically set the font size of the message content (“The signal seemed not good just now”) in the input box 501 according to a dynamic trigger duration (e.g., dynamic trigger duration information) of the trigger operation. For example, the font size of the message content may be increased to the one shown in FIG. 6 when the dynamic trigger duration is t1. Moreover, when the local device dynamically sets the font size and font boldness of the message content in the input box according to the dynamic trigger duration of the trigger operation, for example, the font size of the message content may be increased and the boldness effect added as those shown in FIG. 7 when the dynamic trigger duration is t2.

It can be seen that because the display attribute of the message content in the input box is dynamically configured in the process when the user “Baibai” performs a trigger operation on the “Send” button 505. The user “Baibai” can directly view the display attribute of the message content to determine the moment for terminating the trigger operation more precisely. The display attribute finally used in the message content would then better satisfy the actual needs of the user “Baibai”.

Step 412: The local device configures a display attribute of the message content in a message box.

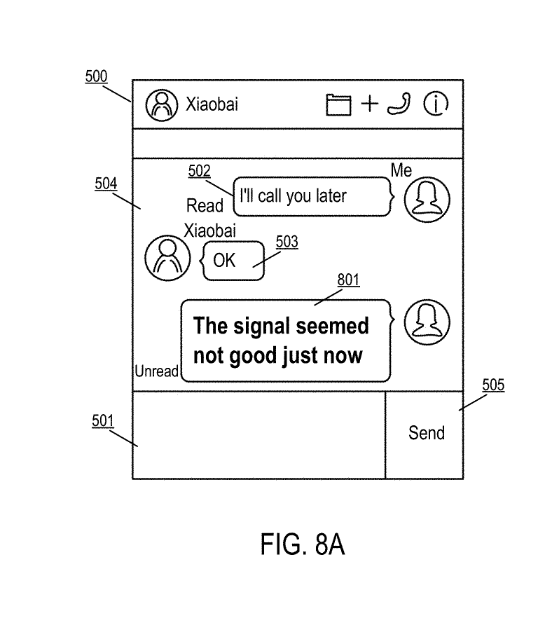

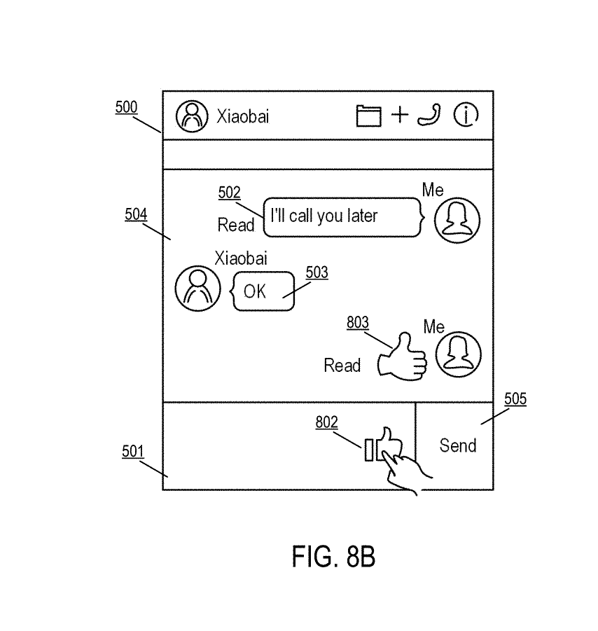

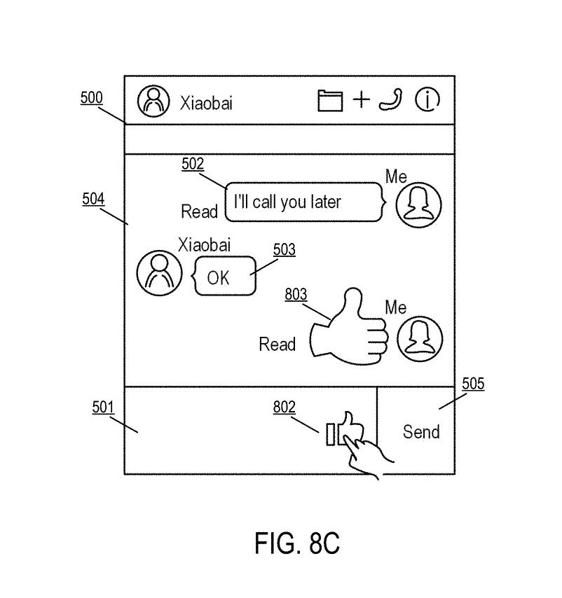

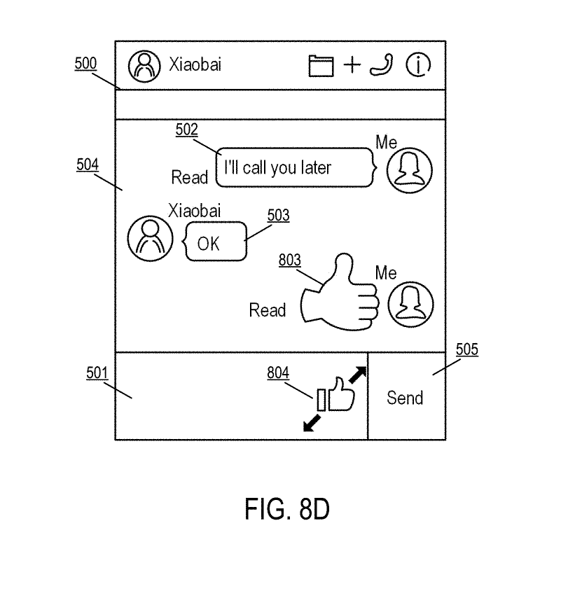

In one embodiment, the local device may acquire message content (assumed to be the message content in the input box 501 shown in FIG. 7) to be displayed on the communication session page 504 and the associated implementation degree information (for example, trigger duration information). At this time, the local device is a sender of the message content and the implementation degree information is used for indicating degree information of a trigger operation for a preset dimension implemented by the sender on a transmission control of the message content. Then, the local device may configure a display attribute of the message content to match a predefined display attribute corresponding to the aforementioned implementation degree information when displaying the message content in the message box on the communication session page. For example, when the user “Baibai” terminates the trigger operation in the situation shown in FIG. 7, the message content 801 displayed in the message box may be shown as that in FIG. 8A. The display attribute of the message content is consistent with the display attribute of the message content in the input box shown in FIG. 7.

In the embodiment shown from FIGS. 5 to 8A, first, message content is input by a local user and displayed in an input box; and then the local user performs a trigger operation of a transmission control so that a local device determines implementation degree information and sends the message content. In other embodiments, multiple operations such as input of message content, determining implementation degree information, and sending of the message content may be partially or fully integrated. By way of example, as shown in FIG. 8B, a “thumbs-up” icon 802 may be displayed on the communication session page 504. For example, the icon 802 may be located in the input box 501 shown in FIG. 8B, so that the local user may perform a trigger operation on the “thumbs-up” icon 801 to send message content 803 containing the “thumbs-up” pattern shown in FIG. 8. When the local user's trigger operation on the “thumbs-up” icon 802 is detected, this means that the local user inputs the “thumbs-up” pattern to the input box 501 and performs sending of the “thumbs-up” pattern.

Further, when the local user performs a trigger operation on the “thumbs-up” icon 802, the local device may determine the implementation degree of the trigger operation to adjust the display attribute of the “thumbs-up” pattern through the technical solutions of the present application. For example, as shown in FIG. 8C, assuming that the implementation degree information is a duration dimension; when a trigger operation on the “thumbs-up” icon 802 is detected, the local device may record trigger duration information of the trigger operation and send the “thumbs-up” pattern 803 and the trigger duration information together to a peer device; the peer device would then be able to configure the display attribute of the “thumbs-up” pattern 803. For example, the display scale (i.e., size) of the “thumbs-up” pattern 803 may be adjusted. Like other embodiments, when the local user performs a trigger operation on the “thumbs-up” icon 802, the implementation degree of the trigger operation may further include other dimensions such as a pressure dimension or a touch area dimension, and is not limited to the aforementioned duration dimension. For example, when the pressure dimension is used, the local device may complete the configuration of the display attribute of the “thumbs-up” pattern 803 according to the detected pressure value of the trigger operation of the local user on the “thumbs-up” icon 802.

Like the aforementioned step 412, the display attribute of a displayed “thumbs-up” pattern 803 may also be configured on the local device according to the implementation degree information. For example, when a display scale of the “thumbs-up” pattern 803 is positively correlated with the trigger duration information, because the detected trigger duration information amount in FIG. 8B is smaller than the detected trigger duration information amount in FIG. 8C, the display scale of the displayed “thumbs-up” pattern 803 in FIG. 8B is smaller than that in FIG. 8C.

For the aforementioned “thumbs-up” solution, while the input of message content may be independent, other multiple operations such as determining the implementation degree information and sending of the message content may be combined. For example, as shown in FIG. 8D, when detecting that the user activates an operation on the “thumbs-up” icon 804, for example, the operation may be a double-click operation on the “thumbs-up” icon 804, the local device may then set the “thumbs-up” icon 804 to an editable state, so that the local user may further perform a trigger operation on the editable “thumbs-up” icon 804. The local user may perform, for example, a “stretching” operation (e.g., sliding on the two touch points in the lower-left direction and the upper-right direction respectively in FIG. 8D) on the “thumbs-up” icon 804. Then, the local device may record a stretching distance or the like of the “stretching” operation as the implementation degree information, and send the corresponding “thumbs-up” pattern 803 and the implementation degree information (for example, the stretching distance) when it is detected that the touch points of the “stretching” operation disappear. For example, the display scale of the “thumbs-up” 803 pattern may increase as the stretching distance gets longer. Likewise, when the local user performs a trigger operation on the editable “thumbs-up” icon 804, a “shrinking” operation may also be performed on the editable “thumbs-up” icon 804. Then, the local device may record a shrinking distance or the like of the “shrinking” operation as the implementation degree information. For example, the display scale of the “thumbs-up” pattern 803 may decrease as the shrinking distance gets longer.

In the disclosed embodiments, when the value of the implementation degree information continuously changes (for example, increases or decreases), a display attribute of message content may be restricted to some extent. Using FIGS. 8B to 8C as an example; assuming that the implementation degree information is trigger duration information and the display attribute is the display scale of the aforementioned “thumbs-up” pattern 803. When the local user continuously performs a trigger operation on the “thumbs-up” icon 802, the display scale of the “thumbs-up” pattern 803 does not increase without limit so the readability of the content is not affected (and even affect readability of other communication messages on the communication session page). In one embodiment, the local device may set the adjustment of the display attribute to “cyclic” changing. Assuming that three display scales that increase the size sequentially are predefined for the “thumbs-up” pattern 803, and the trigger duration information and the display scales have a corresponding relationship in which the changing occurs in ascending order of size, and the changing frequency is once per second; then, when the trigger duration information is 1 s, the corresponding display attribute is a display scale 1. When the trigger duration information is 2 s, the corresponding display attribute is a display scale 2. When the trigger duration information is 3 s, the corresponding display attribute is a display scale 3. When the trigger duration lasts longer, for example, when the trigger duration information is 4 s, the “cyclic” changing principle is applied. Based on the “cyclic” changing principle in which display scale 1→display scale 2→display scale 3 is used as a cycle, the entire cycle is completed when the trigger duration information is 3 s; and thus when the trigger duration information is 4 s, the display attribute may return to the display scale 1. When the trigger duration information is 5 s, the corresponding display attribute is the display scale 2, and so on. In another situation in which display scale 1→display scale 2→display scale 3→display scale 2 is used as a cycle, when the trigger duration information is 4 s, the display attribute may return to the display scale 2, it is then determined that the entire cycle is completed at this time. Then, when the trigger duration information is 5 s, the display attribute may return to the display scale 1, and so on. Certainly, the aforementioned “cyclic” changing process may also be applied to other embodiments of the present application. Details will not be described herein again but is included herein by reference.

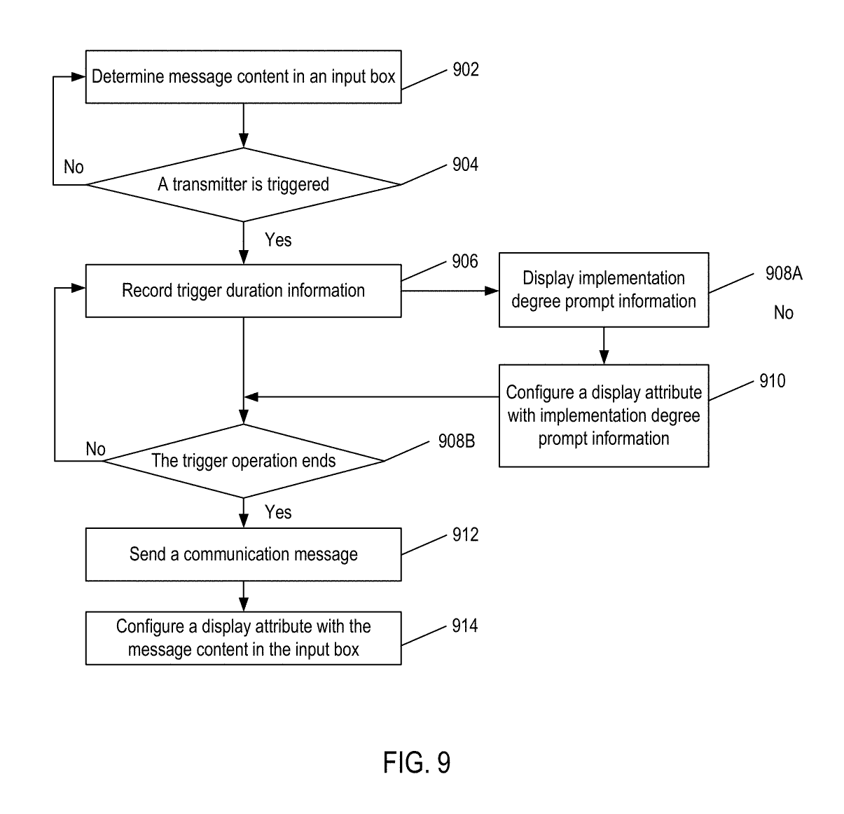

FIG. 9 is a flow diagram illustrating another communication method according to some embodiments of the disclosure. The method is applied to a local device and may include the following steps.

Step 902: The local device determines message content in an input box of a communication session page.

Step 904: When the local device detects that a transmission control for the input box is triggered, move to step 906.

Step 906: The local device records the trigger duration information.

In one embodiment, reference may be made to steps 402 to 406 shown in the aforementioned FIG. 4 for steps 902 to 906, which will not be described herein again but is incorporated herein by reference.

Step 908A: The local device displays implementation degree prompt information.

In one embodiment, the implementation degree prompt information matches implementation degree information of a trigger operation and is used for giving a prompt for an implementation degree of the trigger operation, so that a local user has an idea about to what extent the implementation degree of the trigger operation implemented by the local user is. The local user can control and adjust the trigger operation based on the implementation degree prompt information, such as continue performing the trigger operation when the local user's needs are not satisfied, or release the trigger operation when the local user's needs are satisfied.

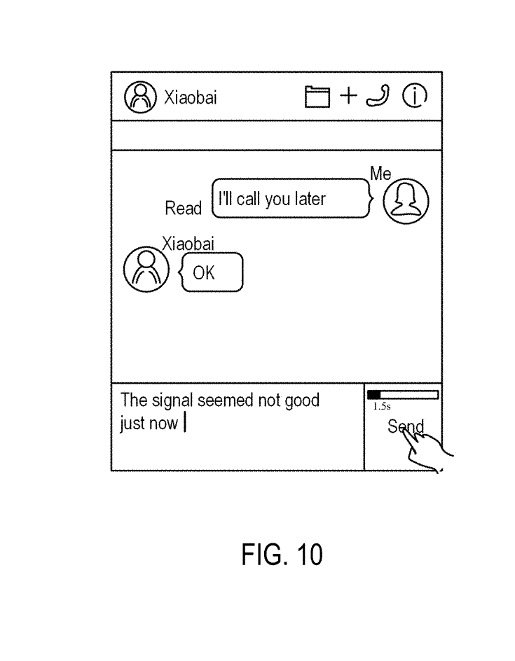

In one embodiment, the implementation degree prompt information may include at least one of the multiple forms, such as text and graphics. By way of example, when the implementation degree information is trigger duration information, the implementation degree prompt information may include at least one of the text “1.5 s”, a progress bar graphic, and so on, as shown in FIG. 10.

For the implementation degree prompt information being represented as a “progress bar,” in an alternative embodiment, the implementation degree of the trigger operation may have certain numerical limitations to maintain readability of the message content. When the progress bar reaches a predefined terminal end (e.g., the trigger duration information reaches a predefined maximum duration), the update of the implementation degree of the trigger operation may be terminated (e.g., the implementation degree information is determined as the predefined maximum value; for example, when the implementation degree information is trigger duration information, the trigger duration information is then determined as the aforementioned predefined maximum duration).

Step 910: The local device configures a display attribute with the implementation degree prompt information.

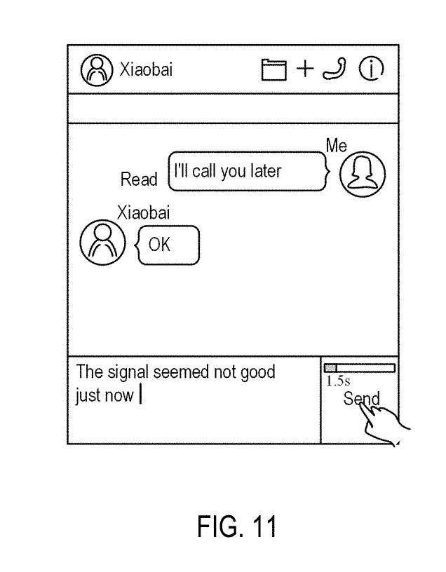

In one embodiment, the local device may configure the display attribute of the implementation degree prompt information according to a dynamic implementation degree of the trigger operation before the trigger operation ends, so that the display attribute of the implementation degree prompt information is configured to match a predefined display attribute. By way of example, assuming that the implementation degree prompt information includes the aforementioned text, progress bar graphic, etc., according to a predefined display attribute corresponding to the according dynamic degree of implementation, for example, assuming that the predefined display attribute includes adjusting the font size and font color of the message content, as shown in FIG. 11: the text “1.5 s” in the implementation degree prompt information may be configured according to the font size contained in the predefined display attribute; and the progress bar graphic in the implementation degree prompt information may be configured according to the font color contained in the predefined display attribute.

The display attribute of the implementation degree prompt information is configured, so that the local user can quickly preview a display attribute of the message content by viewing the implementation degree prompt information. The local user can determine the moment for terminating the trigger operation more accurately; and the display attribute finally used in the message content would better meet the actual needs of the local user.

Step 908B: When the local device detects that the trigger operation ends, move to step 912; otherwise, return to step 906.

Step 912: The local device sends a communication message.

Step 914: The local device configures a display attribute with the message content in a message box.

In one embodiment, reference may be made to step 412 in the embodiment shown in FIG. 4 for step 914, which will not be described herein again but is incorporated herein by reference.

It should be noted that FIG. 4 provides performing a configuration operation on a display attribute of the message content in the input box through step 410B and so on; and this technical solution may also apply to FIG. 9 or other embodiments of the present application to further improve control precision of the trigger operation by the local user, which is not intended to limit the disclosed embodiments. Similarly, FIG. 9 provides the illustration of displaying implementation degree prompt information through step 908A; and this technical solution may also apply to FIG. 4 or other embodiments of the present application to further improve control precision of the trigger operation by the local user, which is not intended to limit the disclosed embodiments. FIG. 9 provides the illustration of performing a configuration operation on a display attribute of the implementation degree prompt information through step 910; and this technical solution may also apply to FIG. 4 or other embodiments of the present application to further improve control precision of the trigger operation by the local user, which is not intended to limit the disclosed embodiments.

In the disclosed embodiments, when the aforementioned communication message is transmitted between the local device and the peer device, for example, in step 410A shown in FIG. 4 and step 912 shown in FIG. 9. In one embodiment, the transmission may be implemented through point-to-pint communication between the local device and the peer device. That is, the local device directly sends the communication message to the peer device based on point-to-pint communication; in another embodiment, the local device may send the communication message to a server of an instant messaging application and then the server further sends the communication message to the peer device. The technical solution of the present application is described below for the communication process among a client 1 on a local device, a client 2 on a peer device, and the aforementioned server.

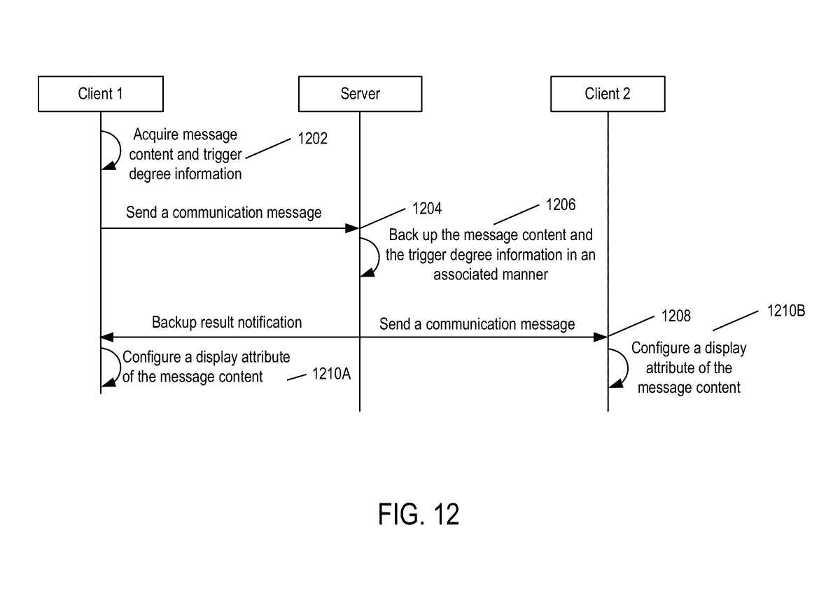

FIG. 12 is a flow diagram illustrating a further communication method according to some embodiments of the disclosure. The method may include the following steps:

Step 1202: Client 1 acquires message content and the associated trigger degree information.

In one embodiment, assuming that client 1 is configured on the local device of the local user “Baibai” in the embodiments shown in FIG. 4 and FIG. 9; and client 1 may acquire message content to be sent and trigger degree information associated with the message content through an embodiment such as that shown in FIG. 4 or FIG. 9, which will not be described herein again but is included herein by reference.

Step 1204: Client 1 sends a communication message containing the aforementioned message content and trigger degree information to the server.

Step 1206: The server backs up the message content and the trigger degree information in an associated manner.

In one embodiment, when client 1 communicates with client 2 through the server, the server may acquire the message content and the trigger degree information respectively from the communication message from client 1. The server may back up the message content and the trigger degree information in an associated manner to serve as historical communication data between client 1 and client 2. Then, because the aforementioned historical communication data is backed up on the server, client 1 or client 2 can request and acquire the historical communication data from the server at any moment. Based on the message content and the trigger degree information included in the historical communication data, client 1 and client 2 may configure a display attribute of the associated message content in an associated manner according to the trigger degree information, to completely reproduce (the display attribute is consistent with that when the message content is first received) the message content. The user may remember corresponding context information, context, or historical events easily by viewing the display attribute of the message content, thereby improving the user's processing efficiency on relevant events.

Step 1208: The server returns a backup result notification to client 1 and sends the aforementioned communication message to client 2.

Step 1210A: Client 1 configures a display attribute of the displayed message content if the backup result notification indicates the backup being successful.

In one embodiment, client 1 may configure the display attribute of the message content according to the trigger degree information upon successful backup; for example, the message content may be displayed as “The signal seemed not good just now” shown in FIG. 8A, and client 1 configures display attributes such as the font size and the boldness of the message content.

In one embodiment, when client 1 does not receive a backup result notification or the received backup result notification indicates the backup fails, the display attribute of the displayed message content may be configured as a default attribute. An example is to use the display attribute consistent with that of “I'll call you later” shown in FIG. 8A. The display attributes such as the font size and boldness will then not be configured.

Step 1210B: Client 2 configures a display attribute of the displayed message content according to the received communication message.

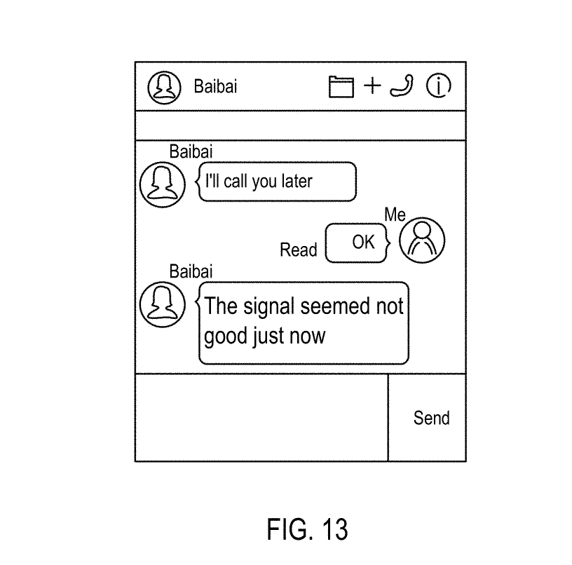

In one embodiment, upon receiving the communication message containing the message content and the implementation degree information, client 2 may configure the display attribute of the message content by parsing a predefined display attribute corresponding to the implementation degree information, to produce a corresponding display effect when displaying the message content on the communication session page shown in FIG. 13. For example, the display effect in FIG. 13 is consistent with the display effect on client 1 shown in FIG. 8A, with both including increasing the font size of the message content with the boldness effect added.

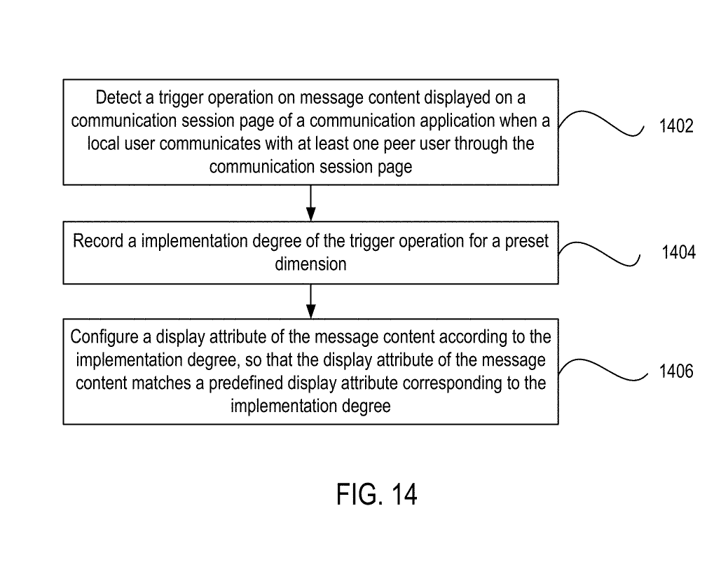

FIG. 14 is a flow diagram illustrating another communication method based on a displayer according to some embodiments of the disclosure. As shown in FIG. 14, the method is applied to an electronic device used by a receiver and may include the following steps.

Step 1402: Detect a trigger operation on message content displayed on a communication session page of a communication application when a local user communicates with at least one peer user through the communication session page.

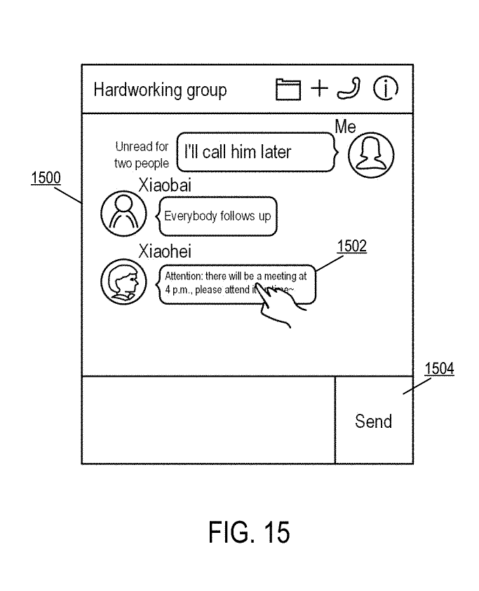

In one embodiment, the message content displayed on the communication session page may come from a sent communication message or a received communication message displayed on the communication session page 1500. For example, as shown in FIG. 15, assuming that the communication session page 1500 is a group chat page of a group “Hardworking group”; for the received communication message from any peer user like “Xiaohei”, for example, a corresponding message content 1502 is “Attention: there will be a meeting at 4 p.m., please attend it on time˜” shown in FIG. 15, the user “Baibai” may touch a message box 1504 that shows the message content to complete the trigger operation on the message content.

Step 1404: Record implementation degree of the trigger operation for a preset dimension.

Step 1406: Configure a display attribute of the message content according to the implementation degree information, so that the display attribute of the message content matches a predefined display attribute corresponding to the implementation degree information.

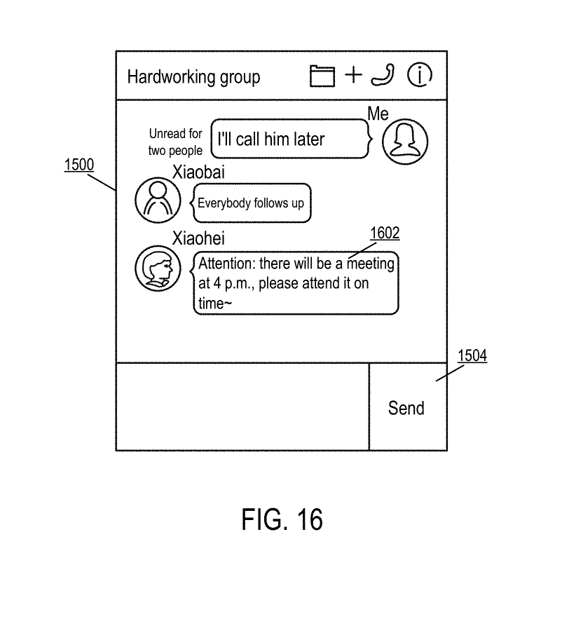

In one embodiment, assuming that an implementation degree of the trigger operation is recorded on a pressure dimension, then, the implementation degree information may be trigger pressure information. Assuming that the manner of adjusting the display attribute of the message content according to the trigger pressure information is the font size of the message content is positively correlated with the trigger pressure information, a local device may adjust the font size of the message content by detecting the pressure value of the trigger operation of the local user. For example, increase the font size of the aforementioned message content (illustrated as message 1602 in FIG. 16) so the display shown in FIG. 15 is changed to that shown in FIG. 16. In other words, the local user can display message content in a focused or highlighted manner by adjusting the display attribute of a received communication message (or sent communication message), thereby achieving a better prompt effect.

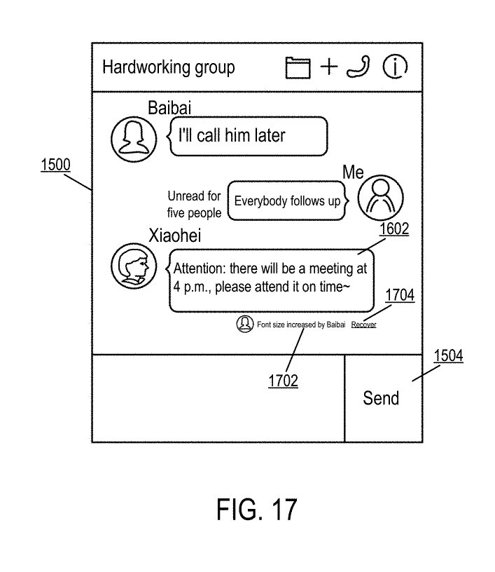

Further, when the local user performs a trigger operation on a received or sent communication message so that the local device acquires corresponding implementation degree information, the local device may further send the implementation degree information to at least one peer user corresponding to a communication session page. The implementation degree information is marked as associated with message content triggered by the local user to instruct a peer device to configure a display attribute of the marked message content according to a predefined display attribute corresponding to the implementation degree information. Assuming that after the user “Baibai” performs a trigger operation on the message content “Attention: there will be a meeting at 4 p.m., please attend it on time˜” shown in FIG. 15 (element 1502), the corresponding implementation degree information may be sent to an electronic device 1 used by the user “Xiaobai.” The implementation degree information is marked as (for example, the implementation degree information is sent in association with the ID of the message content, or the implementation degree information is sent in association with the message content) being associated with the aforementioned message content (i.e., “Attention: there will be a meeting at 4 p.m., please attend it on time˜”), so that the electronic device 1 may adjust the display attribute of the aforementioned message content displayed thereof to that shown in FIG. 17, for example, the adjustment may include increasing the font size.

The electronic device 1 may further display information related to the adjustment operation of the display attribute at the corresponding message content. For example, as shown in FIG. 17, on the communication session page 1500 displayed by the electronic device 1 used by the user “Xiaobai”, when the user “Baibai” adjusts the display attribute of the message content 1602 (“Attention: there will be a meeting at 4 p.m., please attend it on time˜”) based on a trigger operation, prompt information 1702 (for example, including a portrait of a user performing the adjustment operation, a user ID, and the adjusted display attribute) such as “Font size increased by Baibai” may be displayed at a message box corresponding to the message content 1602 on the electronic device 1. Further, a “Recover” option 1704 shown in FIG. 17 may further be provided, so that when the “Recover” option 1704 is triggered, the display attribute of the corresponding message content may be recovered to a default attribute to implement the self-defined control.

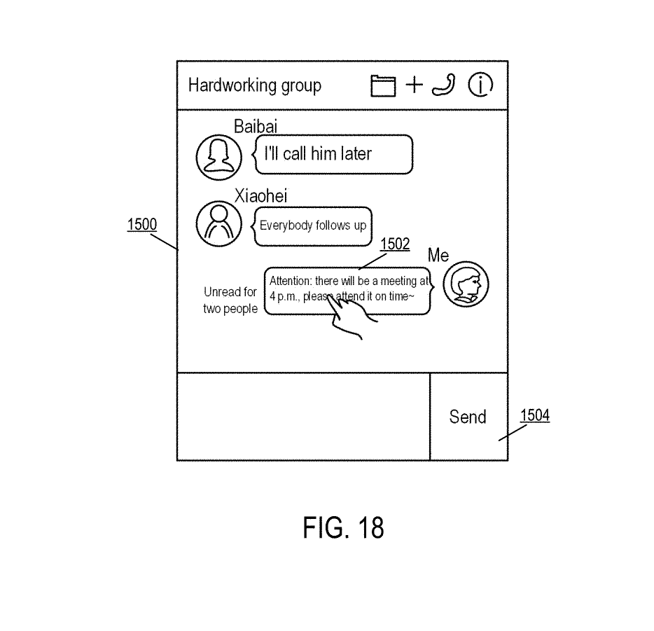

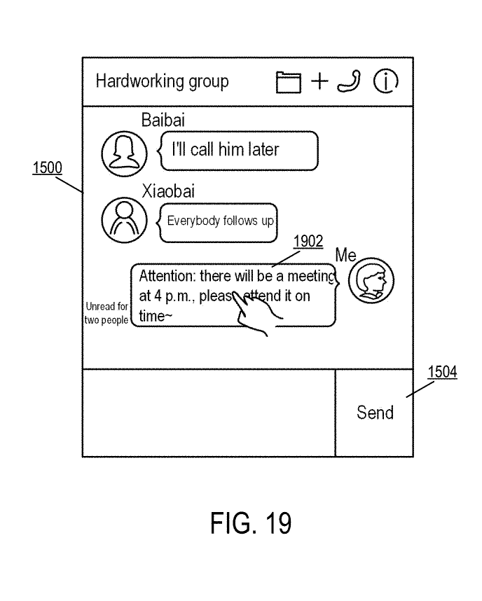

Accordingly, for the user “Xiaohei”, the aforementioned message content “Attention: there will be a meeting at 4 p.m., please attend it on time˜” is a sent communication message of the user “Xiaohei”. Assuming that the user “Xiaohei” uses an electronic device 2, and then, the user “Xiaohei” may perform a trigger operation on a message box corresponding to the aforementioned message content 1502 on the communication session page 1500 displayed by the electronic device 2, shown in FIG. 18. Based on implementation degree of the trigger operation, the electronic device 2 will then be able to configure a display attribute of the message content, like adjusting the display attribute of the message content 1902 from the display attribute shown in FIG. 18 to the display attribute shown in FIG. 19. Further, the electronic device 2 may send the implementation degree of the trigger operation performed by the user “Xiaohei” to at least one receiver of the message content 1502 (i.e., “Attention: there will be a meeting at 4 p.m., please attend it on time˜”), and the implementation degree information is marked as associated with the message content, so that the receiver can adjust the display attribute of the message content accordingly. Then, by means of this embodiment, even if a local user forgets to adjust the display attribute of message content based on the embodiment shown in FIG. 2, the local user can adjust the display attribute of the message content after completing sending the message content without needing to resend the message content, which helps to simplify user operations and improve the communication efficiency.

Certainly, the prompt information “Font size increased by Baibai” 1702 and the “Recover” option 1704 shown in FIG. 17 may also be applied to the embodiment shown in FIGS. 18 and 19, which will not be described herein again but is included herein by reference.

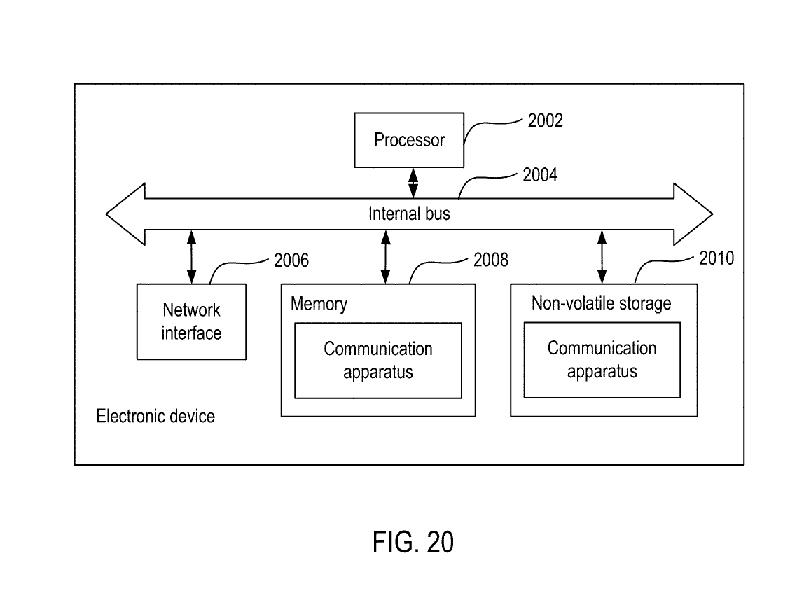

FIG. 20 is a block diagram of an electronic device according to some embodiments of the disclosure.

Referring to FIG. 20, the electronic device includes a processor 2002, an internal bus 2004, a network interface 2006, a memory 2008, and a non-volatile storage 2010 at the hardware level, and certainly may further include hardware needed for other services. The processor 2002 reads a corresponding computer program into the memory 2008 from the non-volatile storage 2010 and then runs the computer program, to form a communication apparatus at the logical level. In addition to the software implementation, the present application also includes other implementations, such as using a logical device or a combination of software and hardware. That is to say, execution bodies of the following processing flows are not limited to logical units, and may also be hardware or logical devices.

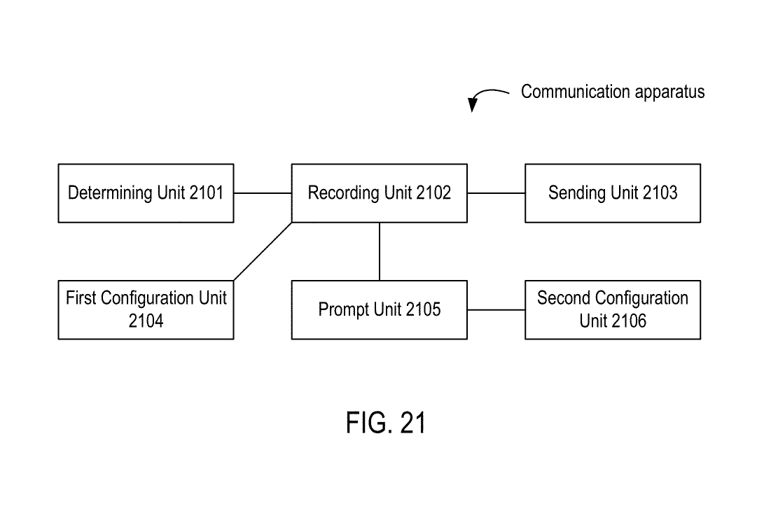

FIG. 21 is a block diagram of a communication apparatus according to some embodiments of the disclosure. The communication apparatus may include a determining unit 2101, a recording unit 2102, and a sending unit 2103.

The determining unit 2101 is used to determine message content in an input box of a communication session page of a communication application when a local user communicates with at least one peer user through the communication session page;

The recording unit 2102 is used to, when a trigger operation of a transmission control for the message content is detected, record implementation degree of the trigger operation for a preset dimension.

The sending unit 2103 is used to send the message content in association with the implementation degree information to a peer device used by the peer user, wherein the implementation degree information is used for instructing the peer device to configure a display attribute of the message content, so that the display attribute of the message content matches a predefined display attribute corresponding to the implementation degree information.

Optionally, the preset dimension includes at least one of a duration dimension, a pressure dimension, and a touch area dimension.

Optionally, the apparatus further includes a first configuration unit 2104, used to configure the display attribute of the message content in the input box according to a dynamic implementation degree of the trigger operation before the trigger operation ends, so that the display attribute of the message content is configured to match the predefined display attribute.

Optionally, the apparatus further includes a prompt unit 2105, used to display implementation degree prompt information for the trigger operation on the communication session page, wherein the implementation degree prompt information is synchronized with the implementation degree information.

Optionally, the apparatus further includes a second configuration unit 2106, used to configure a display attribute of the implementation degree prompt information according to a dynamic implementation degree of the trigger operation before the trigger operation ends, so that the display attribute of the implementation degree prompt information is configured to match the predefined display attribute.

Optionally, the sending unit 2103 is specifically used to send the message content and the implementation degree information to a server of the communication application, so that the server backs up the message content and the implementation degree information in an associated manner and then sends the message content associated with the implementation degree information to the peer device.

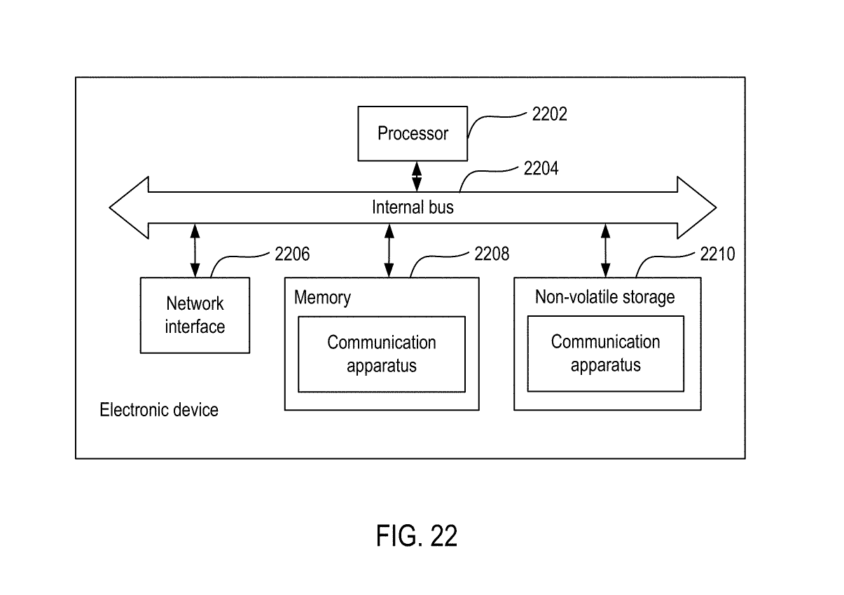

FIG. 22 is a block diagram of another electronic device according to some embodiments of the disclosure. The electronic device includes a processor 2202, an internal bus 2204, a network interface 2206, a memory 2208, and a non-volatile storage 2210 at the hardware level, and certainly may further include hardware needed for other services. The processor 2202 reads a corresponding computer program into the memory 2208 from the non-volatile storage 2210 and then runs the computer program, to form a communication apparatus at the logical level. In addition to the software implementation, the present application may certainly include other implementations, such as using a logical device or a combination of software and hardware. That is to say, execution bodies of the following processing flows are not limited to logical units, and may also be hardware or logical devices.

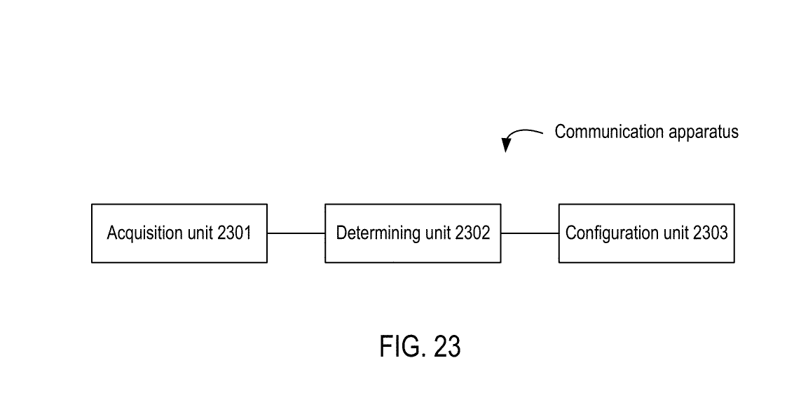

FIG. 23 is a block diagram of another communication apparatus according to some embodiments of the disclosure. In a software implementation, the communication apparatus may include an acquisition unit 2301, a determining unit 2302, and a configuration unit 2303.

The acquisition unit 2301 is used to acquire message content to be displayed on a communication session page of a communication application when a local user communicates with at least one peer user through the communication session page.

The determining unit 2302 is used to determine implementation degree information associated with the message content, wherein the implementation degree information comes from a sender of the message content and is used for indicating degree information of a trigger operation for a preset dimension implemented by the sender on a transmission control of the message content.

The configuration unit 2303 is used to display the message content on the communication session page, and to configure a display attribute of the message content to match a predefined display attribute corresponding to the implementation degree information.

Optionally, the message content includes at least one of the following: a sent message sent by the local user to the peer user; and a received message sent by the peer user to the local user.

Optionally, the message content comes from at least one of the following: a communication message transmitted between the local user and the peer user in real time; and historical communication data read by the local user from a local storage space or a server of the communication application.

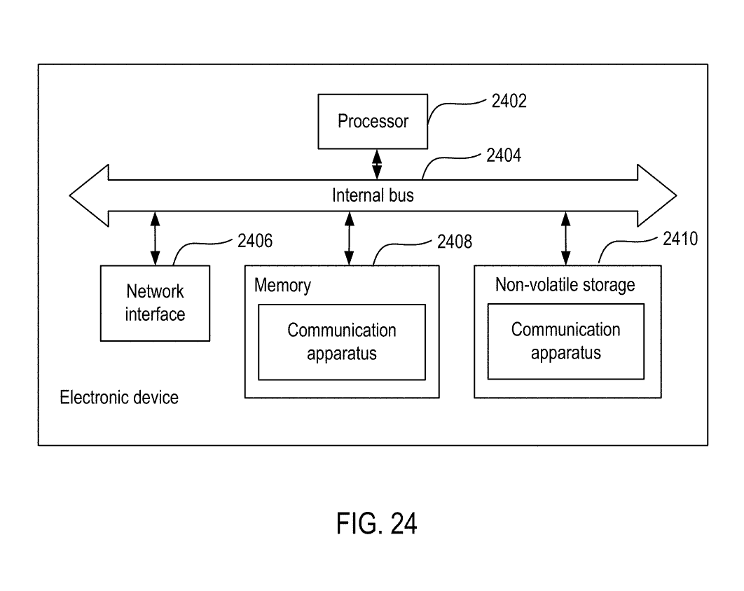

FIG. 24 is a block diagram of an electronic device according to some embodiments of the disclosure. The electronic device includes a processor 2402, an internal bus 2404, a network interface 2406, a memory 2408, and a non-volatile storage 2410 at the hardware level, and certainly may further include hardware required by other services. The processor 2402 reads a corresponding computer program into the memory 2408 from the non-volatile storage 2410 and then runs the computer program, to form a communication apparatus at the logical level. In addition to the software implementation, the present application may certainly include other implementations, such as using a logical device or a combination of software and hardware. That is to say, execution bodies of the following processing flows are not limited to logical units, and may also be hardware or logical devices.

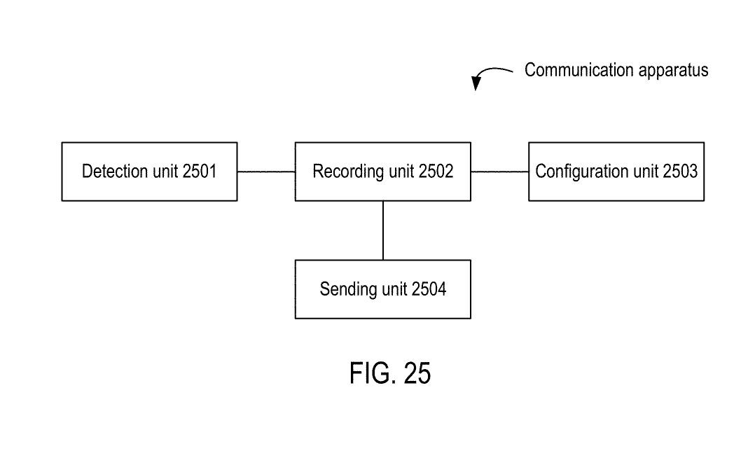

FIG. 25 is a block diagram of a communication apparatus according to some embodiments of the disclosure. In a software implementation, the communication apparatus may include a detection unit 2501, a recording unit 2502, and a configuration unit 2503.

The detection unit 2501 is used to detect a trigger operation on message content displayed on a communication session page of a communication application when a local user communicates with at least one peer user through the communication session page.

The recording unit 2502 is used to record implementation degree of the trigger operation for a preset dimension.

The configuration unit 2503 is used to configure a display attribute of the message content according to the implementation degree information, so that the display attribute of the message content matches a predefined display attribute corresponding to the implementation degree information.

Optionally, the apparatus further includes a sending unit 2504, used to send the implementation degree information to the peer user, wherein the implementation degree information is marked as associated with the message content to instruct a peer device used by the peer user to configure a display attribute of the message content to match the predefined display attribute.

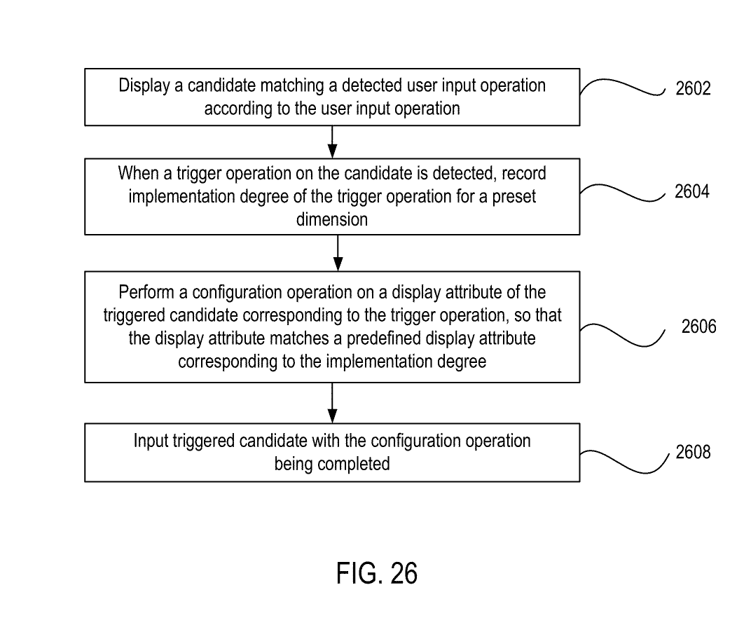

FIG. 26 is a flow diagram illustrating an input method according to some embodiments of the disclosure. As shown in FIG. 26, the method may be applied to an electronic device and include the following steps.

Step 2602: Display a candidate matching a detected user input operation according to the user input operation.

In one embodiment, the electronic device may include a mobile device such as a mobile phone or a tablet, or may include an electronic device such as a PC, which is not intended to limit the disclosed embodiments. An input operation based on the technical solutions of the present application can be done by running an input method client based on the present application on the electronic device. For example, a user can run the input method client by installing an input method application on the electronic device.

In one embodiment, the user can wake up the aforementioned input method client in any scenario such as an input box of a communication application, a text area, or a search box on a browser, to complete an input operation based on the present application.

In one embodiment, the candidate includes at least one of the following:

1) Characters matching the user input operation. For example, when the user input operation clicks keys “H” and “A” on the input method client, matching characters, for example, English characters “HA” and “ha” or Chinese characters “ [symbol] ” and “ [symbol] ”, may be provided, and a predefined emoji such as “̂_̂” may further be included.

2) Pattern matching the user input operation. For example, the input method client may have several patterns, like emoticons, built therein in advance. A corresponding “Smiley” pattern and so on may be obtained by matching according to the keys “H” and “A” clicked by the user input operation.

3) Pattern matching the characters. Like (2), the input method client may first match the characters in (1), and then match a pattern corresponding to the characters according to a predefined mapping relationship between characters and patterns, which will not be described herein again but is included herein by reference.

Step 2604: When a trigger operation on the candidate is detected, record implementation degree of the trigger operation for a preset dimension.

In one embodiment, like step 204 in the embodiment shown in FIG. 2, the preset dimension may include at least one of the following: a duration dimension, a pressure dimension, a touch area dimension, and so on, which will not be described herein again but is included herein by reference.

Step 2606: Perform a configuration operation on a display attribute of the triggered candidate corresponding to the trigger operation, so that the display attribute matches a predefined display attribute corresponding to the implementation degree information.

Step 2608: Input the triggered candidate with the configuration operation being completed.

In one embodiment, the implementation degree information of a trigger operation is recorded, which enables the trigger operation to implement a “selection” function (e.g., selecting a candidate to be input from several candidates) in the relevant art; the trigger operation may further configure a display attribute of the selected candidate, without requiring the user to further perform a configuration operation after completing the input, simplifying user operations.

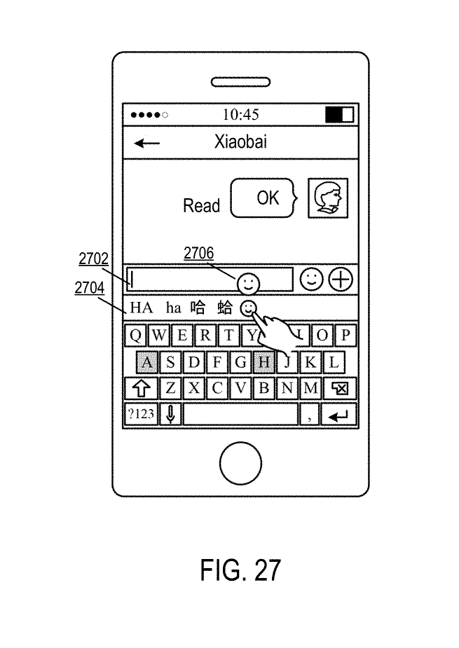

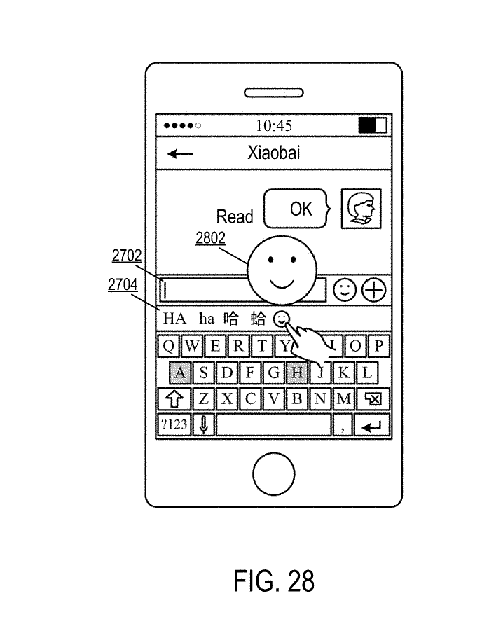

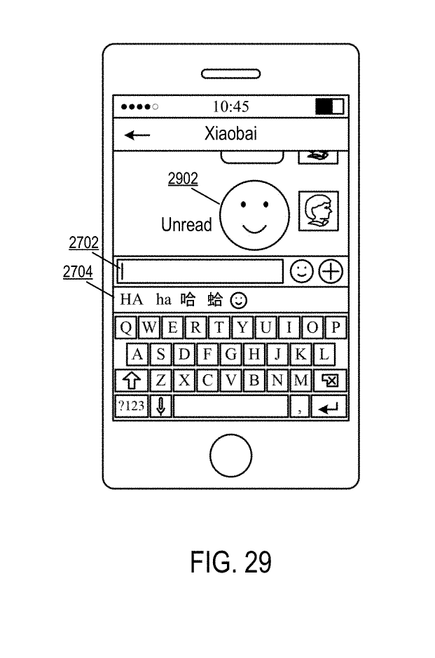

For example, as shown in FIG. 27, assuming that the user input operation is a click operation for “H” and “A” on an input method keyboard 2702, the input method may obtain corresponding candidates 2704 via matching, like the characters “HA”, “ha”, “ [symbol] ”, and “ [symbol] ” and the “Smiley” pattern shown in FIG. 27. Using the user's input of the “Smiley” pattern as an example, assuming that the implementation degree information is trigger duration information and the display attribute is a display scale. When the input method detects a trigger operation (for example, a touch click operation) of the user on the “Smiley” candidate, first, a “Smiley” pattern 2706 having a default display scale may be displayed near (above the smiley in FIG. 27) the “Smiley” candidate. Then the display scale of the “Smiley” pattern 2802 displayed near the “Smiley” candidate increases, for example, to the one shown in FIG. 28 as the duration of the trigger operation increases. Then, when the trigger operation ends in the situation shown in FIG. 28, the input method may configure the “Smiley” candidate according to the display scale corresponding to the current trigger duration information and input the configured “Smiley” pattern; for example, the input “Smiley” pattern 2902 may be sent directly to a peer user through a communication session page in FIG. 29. Certainly, the “Smiley” pattern may be input to an input box first and then sent based on a sending operation of the local user, which is not intended to limit the disclosed embodiments.

It should be noted that like the embodiment shown from FIGS. 8B to 8D or other embodiments of the present application, the “cyclic” changing manner described above may be employed to cyclically adjust the display scale of the “Smiley” candidate, which will not be described herein again but is included herein by reference.

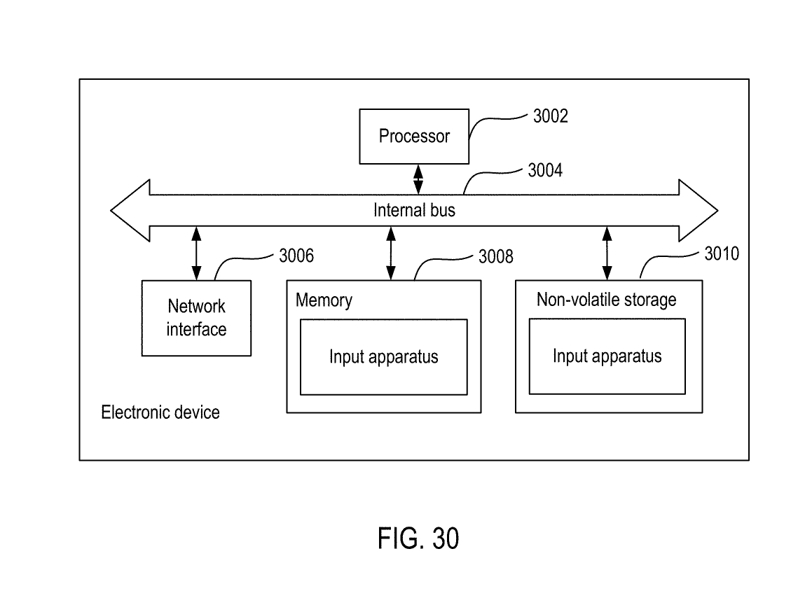

FIG. 30 is a schematic structural diagram of an electronic device according to an exemplary embodiment of the present application. Please refer FIG. 30. The electronic device includes a processor 3002, an internal bus 3004, a network interface 3006, a memory 3008, and a non-volatile storage 3010 at the hardware level, and certainly may further include hardware needed for other services. The processor 3002 reads a corresponding computer program into the memory 3008 from the non-volatile storage 3010 and then runs the computer program, to form a communication apparatus at the logical level. In addition to the software implementation, the present application may certainly include other implementations, such as using a logical device or a combination of software and hardware. That is to say, execution bodies of the following processing flows are not limited to logical units, and may also be hardware or logical devices.

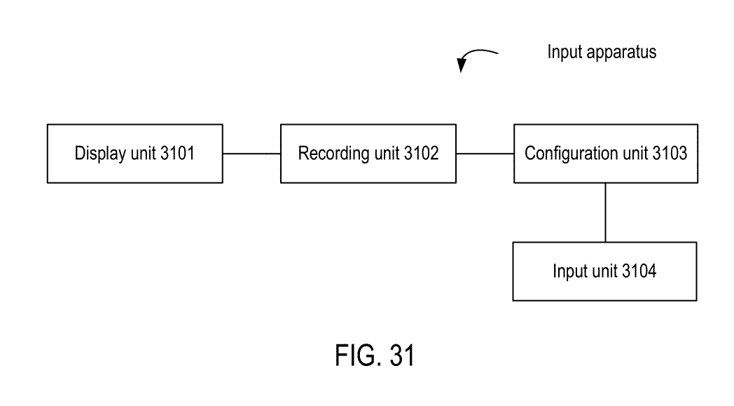

Please refer to FIG. 31. In a software implementation, the communication apparatus may include a display unit 3101, a recording unit 3102, a configuration unit 3103, and an input unit 3104.

The display unit 3101 is used to display a candidate matching a detected user input operation according to the user input operation.

The recording unit 3102 is used to, when a trigger operation on the candidate is detected, record implementation degree of the trigger operation for a preset dimension.

The configuration unit 3103 is used to perform a configuration operation on a display attribute of the triggered candidate corresponding to the trigger operation, so that the display attribute matches a predefined display attribute corresponding to the implementation degree information.

The input unit 3104 is used to input the triggered candidate with the configuration operation being completed.

Optionally, the candidate includes at least one of the following: a character matching the user input operation, and a pattern matching the user input operation or the character.

The system, apparatus, module, or unit illustrated in the aforementioned embodiments may be specifically implemented by a computer chip or an entity, or a product having a certain function. A typical implementation device is a computer, and the specific form of the computer may be a personal computer, a laptop computer, a cell phone, a camera phone, a smart phone, a personal digital assistant, a media player, a navigation device, an email transmission and reception device, a game console, a tablet computer, a wearable device, or a combination of any of these devices.

In a typical configuration, the computer includes one or more processors (CPUs), input/output interfaces, network interfaces and memories.

The memory may include a computer readable medium in the form of a non-permanent memory, a random access memory (RAM) and/or a non-volatile memory or the like, such as a read-only memory (ROM) or a flash memory (flash RAM). The memory is an example of a computer readable medium.

The computer readable medium includes permanent and non-permanent, movable and non-movable media that can achieve information storage by means of any methods or techniques. The information may be computer readable instructions, data structures, modules of programs or other data. Examples of storage medium of computer include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technologies, read-only compact disc read-only memory (CD-ROM), digital versatile disk (DVD) or other optical storages, magnetic cassette, magnetic tape, magnetic disk storage or other magnetic storage devices, or any other non-transmission medium that can be used for storing information accessible by a computing device. In light of the definitions herein, the computer readable medium does not include transitory computer readable media (transitory media), such as modulated data signals and carrier waves.

It should be noted that the term “include”, “comprise”, or any other variation thereof is intended to encompass a non-exclusive inclusion so that a process, method, commodity, or device that includes a series of elements includes not only those elements but also other elements not explicitly listed, or elements that are inherent to such a process, method, commodity, or device. The element defined by the statement “including one . . . ”, without further limitation, does not preclude the presence of additional identical elements in the process, method, commodity, or device that includes the element.

Exemplary embodiments described herein, and examples thereof have been shown in the drawings. The description of the embodiments refers to the drawings in which the same numbers in different drawings represent the same or similar elements unless otherwise indicated. Implementations described in the embodiments are not representative of all implementations consistent with the present application. Instead, they are merely examples of apparatuses and methods consistent with some aspects of the present application as recited in the appended claims.

The terms used in the present application are for the purpose of describing particular embodiments only and are not intended to limit the present application. The singular forms “a”, “an” and “the” used in the present application and the appended claims are also intended to include plural forms, unless the context clearly indicates otherwise. It should also be understood that the term “and/or” as used herein refers to and encompasses any or all possible combinations of one or more of the associated listed items.

It should be understood that although various types of information may be described using terms such as first, second, and third in the present application, such information should not be limited by these terms. These terms are only used to distinguish one type of information from another type of information. For example, first information may also be referred to as second information; similarly, second information may also be referred to as first information without departing from the scope of the present application. Depending on the context, the word “if” as used herein may be construed to mean “when . . . ” or “upon . . . ” or “in response to determining”.

The above descriptions are merely some embodiments of the present application, and are not intended to limit the present application. Any alterations, equivalent substitutions, improvements and the like made within the spirit and principle of the present application shall fall within the protection scope of the present application.

What is claimed is:

1. A method comprising:
identifying message content in an input box of a communication session page of a communication application;
recording an implementation degree of a trigger operation for a preset dimension in response to detecting the trigger operation; and
sending the message content and the implementation degree to a peer device, wherein the implementation degree causes the peer device to configure a display attribute of the message content, such that the display attribute of the message content matches a predefined display attribute corresponding to the implementation degree.

2. The method of claim 1, wherein the communication session page comprises one of a private chat page or a group chat page.

3. The method of claim 1, wherein the preset dimension comprises one of a duration, pressure, or touch area dimension.

4. The method of claim 1 wherein, recording an implementation degree of a trigger operation for a preset dimension in response to detecting the trigger operation further comprises configuring the display attribute of the message content in the input box according to a dynamic implementation degree of the trigger operation before the trigger operation ends, such that the display attribute of the message content is configured to match the predefined display attribute.

5. The method of claim 1, further comprising displaying implementation degree prompt information for the trigger operation on the communication session page, the implementation degree prompt information synchronized with the implementation degree information.

6. The method of claim 5, further comprising configuring the display attribute of the implementation degree prompt information according to a dynamic implementation degree of the trigger operation before the trigger operation ends, such that the display attribute of the implementation degree prompt information is configured to match the predefined display attribute.

7. The method of claim 1, wherein sending the message content and the implementation degree to a peer device comprises sending the message content and the implementation degree to a server of the preset communication application.

8. The method of claim 1 further comprising:
receiving second message content;
determining a second implementation degree associated with the message content; and
displaying the second message content on the communication session page, and configuring a second display attribute of the second message content to match a second predefined display attribute corresponding to the second implementation degree.

9. The method of claim 8, wherein the second message content comprises historical communication data read from a local storage space or a server.

10. An apparatus comprising:
a processor; and
a storage medium for tangibly storing thereon program logic for execution by the processor, the stored program logic comprising:
logic for identifying message content in an input box of a communication session page of a communication application;
logic for recording an implementation degree of a trigger operation for a preset dimension in response to detecting the trigger operation; and
logic for sending the message content and the implementation degree to a peer device, wherein the implementation degree causes the peer device to configure a display attribute of the message content, such that the display attribute of the message content matches a predefined display attribute corresponding to the implementation degree.

11. The apparatus of claim 10, wherein the communication session page comprises one of a private chat page or a group chat page.

12. The apparatus of claim 10, wherein the preset dimension comprises one of a duration, pressure, or touch area dimension

13. The apparatus of claim 10, wherein, the logic for recording an implementation degree of a trigger operation for a preset dimension in response to detecting the trigger operation further comprises logic for configuring the display attribute of the message content in the input box according to a dynamic implementation degree of the trigger operation before the trigger operation ends, such that the display attribute of the message content is configured to match the predefined display attribute.

14. The apparatus of claim 10, further comprising logic for displaying implementation degree prompt information for the trigger operation on the communication session page, the implementation degree prompt information synchronized with the implementation degree information.

15. The apparatus of claim 14, further comprising logic for configuring the display attribute of the implementation degree prompt information according to a dynamic implementation degree of the trigger operation before the trigger operation ends, such that the display attribute of the implementation degree prompt information is configured to match the predefined display attribute

16. The apparatus of claim 10, wherein the logic for sending the message content and the implementation degree to a peer device comprises logic for sending the message content and the implementation degree to a server of the preset communication application

17. The apparatus of claim 10, further comprising:
logic for receiving second message content;
logic for determining a second implementation degree associated with the message content; and
logic for displaying the second message content on the communication session page and logic for configuring a second display attribute of the second message content to match a second predefined display attribute corresponding to the second implementation degree.

18. The apparatus of claim 17, wherein the second message content comprises historical communication data read from a local storage space or a server.

19. An input method, comprising:
displaying a candidate matching a detected user input operation according to the user input operation;
detecting a trigger operation and recording an implementation degree of the trigger operation on a preset dimension;
performing a configuration operation on a display attribute of the candidate corresponding to the trigger operation, the display attribute matching a predefined display attribute corresponding to the implementation degree; and
inputting the candidate with the configuration operation being completed.

20. The method according to claim 19, wherein the candidate comprises at least one of the following: a character matching the user input operation or a pattern matching the user input operation or the character.
